(19) United States
(12) Patent Application Publication
(10) Pub. No.: US 2025/0048145 A1
(43) Pub. Date: Feb. 6, 2025

(54) Electronic Device with Idle Mode Out-of-Service Mitigation Capabilities

(71) Applicant: Apple Inc., Cupertino, CA (US)

(72) Inventors: Anshul Kumar Gupta, Bangalore (IN); Piyush Kumar Garg, Bangalore (IN); B Raju A. N.V., Bangalore (IN); Shrinidhi Ramachandra, Bangalore (IN)

(21) Appl. No.: 18/761,909

(22) Filed: Jul. 2, 2024

Related U.S. Application Data
(60) Provisional application No. 63/517,412, filed on Aug. 3, 2023.

(51) Int. Cl. H04W 24/08

(52) U.S. Cl. CPC H04W 24/08

(57) ABSTRACT

A communications system may include a user equipment (UE) device that communicates with a cellular network having base stations. A UE may enter a connected mode in which the UE and a first base station in a first cell convey wireless data. While in connected mode, the first base station may transmit measurement objects to the UE, each being associated with a different cell neighboring the first cell. The UE may store the measurement objects. When the UE enters an idle mode, the UE may perform measurements on the neighboring cells using the measurement objects. The UE may then use the measurements to determine whether to re-select to a neighbor cell when the UE is unable to acquire a measurement configuration from the base station in idle mode. This may help to mitigate the occurrence of idle mode out-of-service (OOS) conditions for the UE device.

This application claims the benefit of U.S. Provisional Patent Application No. 63/517,412, filed Aug. 3, 2023, which is hereby incorporated by reference herein in its entirety.

### FIELD

This disclosure relates generally to wireless communications, including wireless communications performed by user equipment devices.

### BACKGROUND

Communications systems can include user equipment devices that convey wireless data with a cellular network. A user equipment device connects to a serving cell of the cellular network and exchanges wireless communications data with the cellular network in a connected mode. When cellular activity is low, the user equipment device enters an idle mode.

If care is not taken, deteriorating conditions at the serving cell can cause user equipment devices in the idle mode to consume an excessive amount of time and power in reconnecting to the network, which deteriorates user experience.

### SUMMARY

A communications system may include user equipment (UE) devices that communicate with a network such as a cellular network having wireless base stations. The base stations may broadcast paging signals that include system information blocks (SIBs). When a UE device is able to decode a minimum amount of the SIBs transmitted by a first base station in a first cell, the UE device may camp on the first cell, may attach to the first cell, and may transition to a radio resource control (RRC) connected mode in which the UE device and the first base station convey wireless data.

While in the connected mode, the first base station may transmit measurement objects to the UE device. Each measurement object may be associated with a different cell neighboring the first cell. The measurement objects may identify at least the frequency resources and radio access technologies (RATs) in use by each of the neighboring cells. The UE device may store the measurement objects in a database. When activity is low, the first base station may release the UE device to transition the UE device to an RRC idle mode. In the RRC idle mode, the UE device may perform measurements on the neighboring cells using the measurement objects. The UE device may then use the measurements to determine whether to re-select to a neighbor cell. This may help to mitigate the occurrence of idle mode out-of-service (OOS) conditions for the UE device, which otherwise delay or disrupt wireless communications.

An aspect of the disclosure provides a method of operating an electronic device. The method can include conveying, using wireless circuitry in a connected mode, wireless data with a first wireless base station. The method can include receiving, using the wireless circuitry in the connected mode, a measurement object from the first wireless base station, the measurement object being associated with a second wireless base station different from the first wireless base station. The method can include measuring, using the wireless circuitry in an idle mode, a radio-frequency signal based on the measurement object, the radio-frequency signal being transmitted by the second wireless base station.

An aspect of the disclosure provides an electronic device. The electronic device can include one or more antennas. The electronic device can include one or more radios coupled to the one or more antennas. The radio can be configured to use the one or more antennas to receive, in a connected mode, wireless data transmitted by a wireless base station in a first cell, to receive, in the connected mode, information transmitted by the wireless base station that identifies a frequency of a second cell neighboring the first cell, and to measure, in an idle mode, a radio-frequency signal at the frequency. The electronic device can include one or more processors configured to perform cell reselection based on the measurement of the radio-frequency signal.

An aspect of the disclosure provides a method of operating a wireless base station in a first cell. The method can include transmitting, using one or more antennas, wireless data to a user equipment (UE) device in the first cell while the UE device is in a radio resource control (RRC) connected mode. The method can include transmitting, using the one or more antennas, a measurement object to the UE device while the UE device is in the RRC connected mode, wherein the measurement object is associated with a second cell different from the first cell. The method can include transitioning, using the one or more antennas, the UE device from the RRC connected mode to an RRC idle mode, the UE device being configured to perform idle mode measurements on the second cell based on the measurement object transmitted by the wireless base station.

### BRIEF DESCRIPTION OF THE DRAWINGS

FIG. 1 is a diagram of an illustrative communications system having a user equipment device that communicates with a serving cell adjacent to one or more neighbor cells in a cellular telephone network in accordance with some embodiments.

FIG. 2 is a schematic block diagram of an illustrative user equipment device in accordance with some embodiments.

FIG. 3 is a diagram showing how an illustrative user equipment device may transition between a connected mode and an idle mode in communicating with a cellular telephone network in accordance with some embodiments.

FIG. 4 is a diagram of illustrative circuitry on a user equipment device that mitigates an out-of-service condition for the user equipment device while in idle mode in accordance with some embodiments.

FIGS. 5 and 6 include a flow chart of illustrative operations that may be performed by a cellular telephone network and a user equipment device to mitigate an out-of-service condition for the user equipment device while in idle mode in accordance with some embodiments.

### DETAILED DESCRIPTION

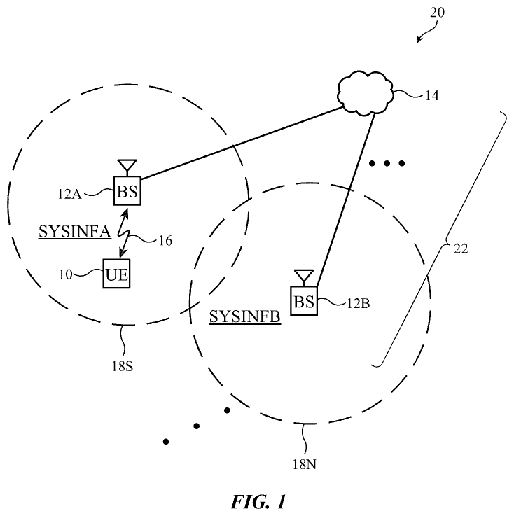

FIG. 1 is a schematic diagram of an illustrative communications system 20 (sometimes referred to herein as communications network 20) for conveying wireless data between communications nodes or terminals. Communications system 20 may include network nodes (e.g., communications terminals). The network nodes may include user equipment (UE) such as one or more UE devices 10. The network nodes may also include external communications equipment (e.g., communications equipment other than UE devices 10) such as external communications equipment 12. External communications equipment 12 may include wireless base stations, wireless access points, or other wireless equipment for example. Implementations in which external communications equipment 12 is a wireless base station (BS) that supports cellular telephone communications (e.g., voice and/or data signals) are described herein as an example. External communications equipment 12 may therefore sometimes be referred to herein as wireless base station 12, gNB 12, or simply as base station 12. UE devices 10 and base station 12 may communicate with each other using wireless communications links. If desired, UE devices 10 may wirelessly communicate with base station 12 without passing communications through any other intervening network nodes in communications system 20 (e.g., UE devices 10 may communicate directly with base station 12 over-the-air).

Communications system 20 may form a part of a larger communications network that includes network nodes coupled to base station 12 via wired and/or wireless links. The larger communications network may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. The larger communications network may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE devices 10 may send data to and/or may receive data from other nodes or terminals in the larger communications network via base stations 12 (e.g., base stations 12 may serve as an interface between UE devices 10 and the rest of the larger communications network).

Some or all of the communications network may, if desired, be operated by a corresponding network operator or service provider. For example, communication system 20 may include a core network (CN) 14 operated by a network operator or service provider. Core network 14 may include end hosts, terminals, network nodes, servers, switches, routers, local area networks, distributed networks, the Internet, or any desired network topology. Core network 14 may control the forwarding of data from UE device 10 to other end hosts of system 20. Core network 14 may control the operation of base stations 12, may serve wireless data for transmission to UE devices 10, may receive wireless data from UE devices 10 (via base stations 12), etc. Core network 14 may be operated by the network operator or service provider of base stations 12 (sometimes referred to herein simply as an “operator”), by a service provider associated with the operating system and/or manufacturer of one or more UE devices 10, or may be any other desired network or sub-network within communications system 20. Core network 14 and base stations 12 may sometimes be referred to collectively herein as network 22 (or simply as “the network”).

Each base station 12 may include one or more antennas (e.g., antennas arranged in one or more phased antenna arrays for conveying signals at frequencies greater than 10 GHz or other antennas for conveying signals at lower frequencies) that provides wireless coverage for UE devices 10 located within a corresponding geographic area or region, sometimes referred to as the coverage area, service area, or cell 18 of the corresponding base station 12. In other words, each base station 12 may have a respective cell 18 in network 22 that covers a corresponding geographic area and each base station 12 may communicate with UE devices 10 located within its cell 18.

Each cell 18 may have any desired shape (e.g., a circular shape, a hexagonal shape, etc.) and may cover any desired area. In general, the size of a cell 18 may correspond to the maximum transmit power level of its base station 12 and the over-the-air attenuation characteristics for radio-frequency signals conveyed by that base station 12, for example. When a UE device 10 is located within a given cell 18, the UE device may connect with the base station 12 (sometimes referred to herein as attaching to base station 12) of that cell 18 and may then communicate with the base station over a wireless link. To support the wireless link, base station 12 may transmit radio-frequency signals in a downlink (DL) direction from base station 12 to the UE device and/or the UE device may transmit radio-frequency signals in an uplink (UL) direction from the UE device to base station 12 (e.g., the wireless links may be bidirectional links).

In the example of FIG. 1, a given UE device 10 may be located in the vicinity of a given base station 12S (e.g., within the cell 18S of base station 12S). UE device 10 may therefore communicate with base station 12S over a corresponding wireless link (sometimes referred to herein as a communications link or wireless connection). Radio-frequency signals 16 (e.g., cellular signals) may be conveyed between UE device 10 and base station 12S to support the wireless link. In this way, base station 12S provides wireless (cellular telephone) services to UE device 10 and may therefore sometimes be referred to herein as serving cell (SC) base station 12S. The cell 18S of SC base station 12S may sometimes be referred to herein as serving cell 18S.

Network 22 may also include one or more neighbor cells 18N that are geographically adjacent to, abutting, and/or overlapping with serving cell 18S. The base station of each neighbor cell 18N may sometimes be referred to herein as a neighbor cell (NC) base station 12N. There may be any desired number of neighbor cells 18N around serving cell 18S (e.g., neighbor cells 18N may completely surround serving cell 18S). Operations performed by SC base station 12S may sometimes be referred to herein as being performed by serving cell 18S. Similarly, operations performed by NC base station(s) 12N may sometimes be referred to herein as being performed by neighbor cell 18N.

Each cell 18 in network 22 may have corresponding system information SYSINF (sometimes referred to herein as cell information SYSINF). For example, serving cell 18S may have system information SYSINFA whereas neighbor cell 18N may have system information SYSINFB. System information SYSINF of a given cell 18 may be set by, configured by, updated by, controlled by, determined by, programmed by, dictated by, and/or otherwise known to the corresponding base station 12, one or more nodes of core network 14, and/or the network operator or service provider associated with network 22. Base station 12 may transmit some or all of its system information SYSINF to the UE devices 10 within its cell 18 (e.g., using radio-frequency signals 16). Base station 12 may transmit this information upon initialization of communications, registration, or attachment of the UE devices to the base station, upon entering a connected mode, whenever the information is updated by the network, and/or periodically.

The structure and contents of system information SYSINF may be determined by, given by, and/or associated with the communications protocol of radio-frequency signals 16 (e.g., the communications protocol with which radio-frequency signals 16 are conveyed). The communications protocol may also specify (e.g., mandate) the schedule with which base station 12 is to transmit some or all of system information SYSINF to the UE devices 10 in its cell 18 as well as the time/frequency resources with which the base station transmits the information. System information SYSINF may, for example, include information identifying temporal resources, frequency resources, and/or a radio access technology (RAT) that are currently being used by base station 12 in communicating with UE devices 10 within its cell 18.

As one example, when radio-frequency signals 16 are conveyed using the 5G NR communications protocol, system information SYSINF may include a master information block (MIB) and a first system information block (SIB1) (e.g., as labeled and structured according to the 3GPP 5G NR communications protocol) associated with communications performed by the corresponding base station 12. Base station 12 may transmit the MIB using a synchronization signal block (SSB) and a physical broadcast channel (PBCH) (e.g., base station 12 may broadcast the MIB), for example. Base station 12 may transmit SIB1 using a physical downlink shared channel (PDSCH). The MIB may, for example, contain information identifying the control channel for the SIB PDSCH, demodulation reference signal (DMRS) information for the PDSCH, information identifying the sub-carrier spacing to be used in conveying radio-frequency signals 16, etc. SIB1 may, for example, include information needed by UE device 10 to perform an initial attachment to base station 12, scheduling information for other system information blocks (e.g., SIB2 through SIB21), etc. UE device 10 may, for example, be able to camp on a cell 18 when the UE device is able to successfully decode the SIB1 and the MIB transmitted by the base station 12 of that cell 18. As another example, when radio-frequency signals 16 are conveyed using the 4G LTE communications protocol, system information SYSINF may include the MIB, SIB1, and a second system information block (SIB2) (e.g., as labeled and structured according to the 3GPP 4G LTE communications protocol). These examples are illustrative and non-limiting and, in general, base station 12 may include any desired information in the system information SYSINF transmitted to the UE devices 10 in its cell 18 to allow the UE devices to camp on the cell and attach to the base station for performing further communications (e.g., in a connected mode).

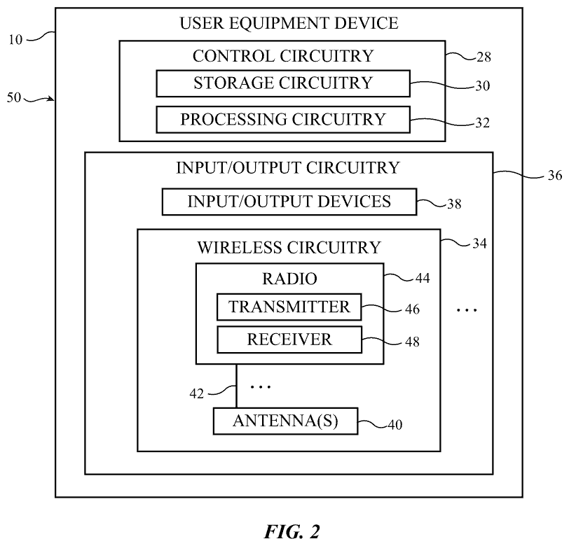

FIG. 2 is a block diagram of an illustrative UE device 10. UE device 10 is an electronic device and may therefore sometimes be referred to herein as electronic device 10 or device 10. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, UE device 10 may include components located on or within an electronic device housing such as housing 50. Housing 50, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 50 may be formed from dielectric or other low-conductivity material (e.g., glass, ceramic, plastic, sapphire, etc.). In other situations, housing 50 or at least some of the structures that make up housing 50 may be formed from metal elements.

UE device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 28 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 28 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as one or more software applications (apps). The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications.

To support interactions with external communications equipment, control circuitry 28 may be used in implementing communications protocols. Communications protocols that may be implemented using control circuitry 28 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 3rd Generation Partnership Project (3GPP) Fourth Generation (4G) Long Term Evolution (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), satellite communications protocols (e.g., for conveying bi-directional data with one or more gateways via one or more communications satellites in a satellite constellation, antenna-based spatial ranging protocols, or any other desired communications protocols. Each communications protocol may be associated with a corresponding radio access technology (RAT) that specifies the physical connection methodology used in implementing the protocol (e.g., an NR RAT, an LTE RAT, a 3G RAT, a WLAN RAT, etc.). Radio-frequency signals conveyed using a cellular telephone protocol may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 44 may be mounted onto a single substrate or integrated into a single integrated circuit, chip, package, or system-on-chip (SOC) or may be distributed between multiple substrates, integrated circuits, chips, packages, or SOCs.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards base station 12 of FIG. 1).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 30 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, cellular sidebands, 6G bands between 100-1000 GHz (e.g., sub-THz, THz, or THF bands), etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The example of FIG. 2 is illustrative and non-limiting. While control circuitry 28 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 28 (e.g., portions of control circuitry 28 may be implemented on wireless circuitry 34). As an example, control circuitry 28 may include baseband circuitry (e.g., one or more baseband processors), digital control circuitry, analog control circuitry, and/or other control circuitry that forms part of radio 44. The baseband circuitry may, for example, access a communication protocol stack on control circuitry 28 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34.

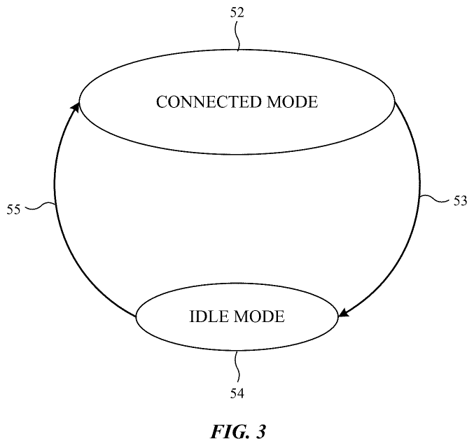

When performing wireless communications with a given SC base station 12S, UE device 10 may operate in and may transition between different communications operating modes or states. For example, as shown in FIG. 3, UE device 10 (wireless circuitry 24 or radio 44) may operate in and switch between a first operating mode (state) such as connected mode 52 and a second operating mode (state) such as idle mode 54.

UE device 10 may enter connected mode 52 after attaching to SC base station 12S (e.g., after initializing communications with SC base station 12S and registering with SC base station 12S for further communications). Connected mode 52 may, for example, be a radio resource control (RRC) connected mode. While in connected mode 52, UE device 10 may convey wireless data with SC base station 12S (e.g., using a physical uplink shared channel (PUSCH) and/or a physical downlink shared channel (PDSCH)). The wireless data may include any desired application data, voice and/or video data (e.g., for a voice and/or video call being performed by UE device 10), control information, etc.

In idle mode 54 (e.g., an RRC idle mode), UE device 10 is not registered to a particular cell does not actively convey wireless data (e.g., uplink and/or downlink data) with SC base station 12S. This may allow UE device 10 to power down, power off, or put to sleep one or more components of wireless circuitry 34 (FIG. 2) to conserve power. However, in idle mode 54, UE device 10 may periodically wake or power up these components to listen for and receive paging signals and/or broadcast signals from base stations 12 (e.g., one or more NC base stations 12N). The paging signals and/or broadcast signals may include synchronization signals, control information (e.g., conveyed over a physical uplink control channel (PUCCH) and/or a physical downlink control channel (PDCCH), and/or some or all of the system information SYSINF (e.g., one or more SIBs) associated with the corresponding cell 18 (e.g., SC base station 12S may broadcast system information SYSINFA to UE devices in serving cell 18S, NC base station 12N may broadcast system information SYSINFB to UE devices in neighbor cell 18N, etc.). UE device 10 may use the information from the paging signals and/or broadcast signals (e.g., system information SYSINF, one or more SIBs, etc.) to perform cell reselection (e.g., to connect to the base station 12 of a different cell 18 than its most recent serving cell 18S), to assess the wireless performance of different cells 18, to detect when there is an incoming call or incoming wireless data for UE device, etc. UE device 10 may operate in other communications operating modes such as an inactive mode. However, these modes have been omitted from FIG. 3 for the sake of clarity.

UE device 10 may transition from connected mode 52 to idle mode 54, as shown by arrow 53, in response to any desired criteria or trigger condition. This transition may sometimes be referred to as connection release (e.g., SC base station 12S may release UE device 10 causing UE device 10 to transition from connected mode 52 to idle mode 54). Connection release may occur when wireless communications by UE device 10 has been inactive (e.g., below a threshold level of activity) for at least a predetermined time period, when no wireless data (e.g., less than a threshold level of wireless data) has been transmitted by UE device 10 or received by SC base station 12S for transmission to UE device 10 for at least the predetermined time period, when wireless performance metric data gathered at SC base station 12S and/or UE device 10 falls below a threshold level, and/or in response to any desired trigger conditions or criteria (e.g., as dictated by the communications protocol governing communications between UE device 10 and SC base station 12S).

UE device 10 may transition from idle mode 54 to connected mode 52, as shown by arrow 55, in response to any desired criteria or trigger condition. This transition may sometimes be referred to as connection establishment. Connection establishment may occur when UE device 10 has wireless uplink data to transmit to the network, when the network has wireless downlink data to transmit to UE device 10 (e.g., an incoming call), when wireless performance metric data gathered at a base station 12 and/or UE device 10 rises above a threshold level, and/or in response to any desired trigger conditions or criteria (e.g., as dictated by the communications protocol governing communications between UE device 10 and base station 12). The base station that UE device 10 establishes a connection with in transitioning from idle mode 54 then becomes the SC base station 12S for UE device 10.

UE device 10 may enter connected mode 52 with the same base station 12 as the SC base station 12S that the UE device was connected to prior to connection release or may, if desired, enter connected mode 52 with a different base station 12 (e.g., a neighbor base station 12N) that is different from the SC base station 12S that the UE device was connected to prior to connection release (e.g., when UE device 10 performs cell reselection or when the network performs handover for UE device 10). In these situations, the different base station then becomes the new (current) SC base station 12S for UE device 10. In this way, UE device 10 may cycle between connected mode 52 and idle mode 54 as needed over time for conveying wireless data with one or more base stations 12.

When performing wireless communications, UE device 10 may camp on a cell 18 (e.g., configuring radio 44 of FIG. 2 to remain at a given frequency at which the UE device will continue to attempt to receive and decode wireless data) when UE device 10 is able to successfully decode at least a minimum (e.g., mandatory) amount of the system information SYSINF transmitted by the corresponding base station 12 (e.g., at least the MIB and SIB1 when communicating using the NR communications protocol, at least the MIB, SIB1, and SIB2 when communicating using the LTE communications protocol, etc.). Once camped on the cell, UE device 10 may immediately transition to connected mode 52. The cell may then form serving cell 18S for UE device 10 and the corresponding base station of that cell may form SC base station 12S for UE device 10 (e.g., UE device 10 of FIG. 1 may immediately transition to connected mode 52 when UE device 10 is able to successfully decode system information SYSINFA transmitted by SC base station 12S).

When UE device 10 immediately transitions to connected mode 52 for communicating with serving cell 18S, there is generally no opportunity for UE device 10 to acquire system information SYSINFB from neighbor cells 18N. Because UE device 10 fails to receive system information SYSINFB (e.g., one or more neighbor cell SIBs) from neighbor cells 18N, UE device 10 is unable to perform measurements (e.g., gather wireless performance metric data) from neighbor cells 18N to assess whether the neighbor cells are candidates for UE device 10 to communicate with and/or to assess whether the neighbor cells offer superior wireless performance for UE device 10 than its current serving cell 18S.

A neighbor cell 18N may operate using the same RAT as serving cell 18S or may operate using a different RAT. As a first example, in implementations where neighbor cell 18N communicates using the 5G NR RAT and communications protocol, UE device 10 may have no opportunity to receive SIBs such as SIB2-SIB5 broadcast by the NC base station 12N in neighbor cell 18N. As a second example, in implementations where neighbor cell 18N communicates using the 4G LTE RAT and communications protocol, UE device 10 may have no opportunity to receive SIBs such as SIB3-SIB8 broadcast by the NC base station 12N in neighbor cell 18N. If care is not taken, this lack of knowledge of system information SYSINFB (e.g., SIBs) from neighbor cell 18N can cause UE device 10 to undesirably enter an out-of-service (OOS) condition or state after transitioning to idle mode 54.

For example, when UE device 10 transitions to idle mode 54 after communicating with SC base station 12S in connected mode 52, if the channel conditions in serving cell 18S deteriorate or fall below a threshold level, UE device 10 may experience cyclic redundancy check (CRC) errors for acquiring the necessary SIBs of system information SYSINFB for neighbor cell 18N. Similarly, when in idle mode 54, UE device 10 can enter a critical cell condition, which begins an OOS timer (e.g., 10 seconds), if serving cell 18S exhibits channel conditions that are even worse, such that UE device 10 is unable to satisfy the serving cell camping criteria of serving cell 18S (sometimes referred to herein as the S-parameters or S-criteria of serving cell 18S). The S-parameters may, for example, require UE device 10 to be able to successfully decode at least system information SYSINFA (e.g., the MIB and SIB1 for 5G NR or the MIB, SIB1, and SIB2 for 4G LTE) to camp on the cell and transition to connected mode with that cell. If UE device 10 is still unable to satisfy the S-parameters after the OOS timer has elapsed, UE device 10 then enters a non-access stratum (NAS) OOS state where the NAS layer on UE device 10 triggers an exhaustive search to reconnect to the network (e.g., a public land mobile network (PLMN) search and initial cell search over all or a relatively wide range of frequencies until system information SYSINF broadcast by a base station 12 is received and successfully decoded at UE device 10). This condition is sometimes referred to herein as UE device 10 being in an idle mode OOS condition.

In these situations, if care is not taken, there is no way for UE device 10 to recover in poor serving cell channel conditions (e.g., UE device 10 will be unable to quickly transition or reselect to a better-performing neighbor cell 18N), as the UE device has not had an opportunity to perform channel measurements from any neighbor cells 18N to its current or most-recent serving cell 18S (e.g., because the UE device has not received the system information SYSINFB of the neighboring cells since the UE device immediately transitioned to connected mode upon camping on serving cell 18S). After the expiry of the OOS timer (e.g., 10 seconds), the NAS layer on UE device 10 (e.g., processing circuitry 32 of FIG. 2) triggers the exhaustive search to reconnect to the network. However, such a NAS layer search consumes an excessive amount of power and can take an excessive amount of time, substantially extending the amount of time the user of UE device 10 must wait until UE device 10 is able to successfully convey wireless data with the network. It would therefore be desirable to be able to provide UE device 10 with a way to recover from such conditions (e.g., within RRC) prior to expiry of the OOS timer. In other words, it would be desirable to be able to prevent or mitigate UE device 10 entering an idle mode OOS condition.

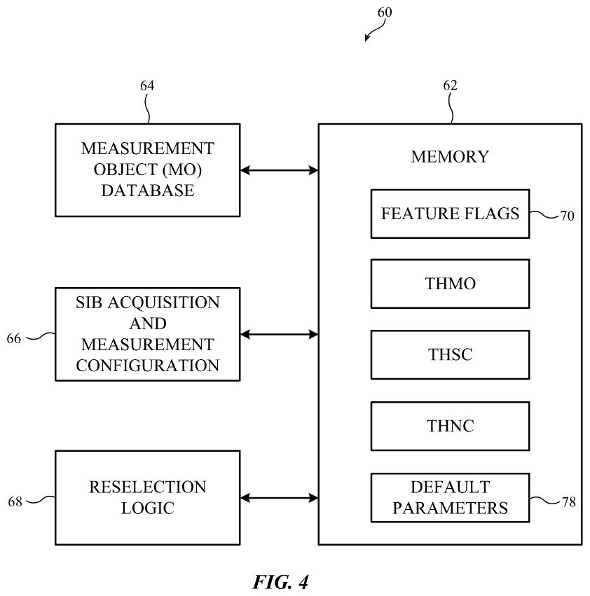

To mitigate these issues, UE device 10 may receive measurement objects for neighbor cells 18N from SC base station 12S while in connected mode and may use the measurement objects to prevent UE device 10 from entering an idle mode OOS condition after UE device 10 has transitioned to idle mode 54. FIG. 4 is a diagram of circuitry 60 on device 10 for use in avoiding an idle mode OOS condition.

As shown in FIG. 4, circuitry 60 may include memory 62 (e.g., in storage circuitry 30 of FIG. 2), a measurement object (MO) database 64 (e.g., stored at storage circuitry 30 of FIG. 2), SIB acquisition and measurement configuration information 66 (e.g., stored at storage circuitry 30 of FIG. 2), and reselection logic 68 (e.g., implemented or performed by processing circuitry 32 of FIG. 2). Memory 62 may include non-volatile memory (NVM), for example.

Memory 62 may include parameters such as one or more feature flags 70, one or more maximum measurement object thresholds THMO, one or more serving cell performance thresholds THSC, one or more neighbor cell performance thresholds THNC, and default reselection parameters 78. Feature flags 70 may, for example, include flags identifying which communications features are enabled or disabled for UE device 10. Threshold THMO may, for example, identify the maximum number of measurement objects storable in MO database 64. Threshold THSC may, for example, include one or more thresholds associated with when the channel conditions of serving cell 18S become unsatisfactory or insufficient. Threshold THNC may, for example, identify a SIB CRC count threshold for a corresponding neighbor cell 18N. Default parameters 78 may, for example, include the default reselection parameters for a MO frequency layer (e.g., treated as a SIB frequency layer).

While operating in connected mode with SC base station 12S, SC base station 12S may transmit one or more measurement objects (MO's) of one or more neighbor cells 18N (e.g., where each measurement object corresponds to an associated neighbor cell 18N). A given measurement object (MO) may, for example, include frequency information (e.g., one or more carriers or frequencies), band information (e.g., a frequency band indicator or identifier, bandwidth information, etc.), synchronization signal block (SSB) based measurement timing configuration (SMTC) information, subcarrier spacing information, RAT information, and/or other information associated with how the corresponding NC base station 12N conveys radio-frequency signals with the UE devices in its neighbor cell 18N. An MO may, for example, at least identify frequency layer information and the RAT being used by the corresponding neighbor cell 18N.

UE device 10 may store each of the measurement objects received from SC base station 12S while in connected mode 52 in MO database 64. In this way, SC base station 12S may inform UE device 10 of measurement objects that can be used by UE device 10 to perform neighbor cell measurements even though UE device 10 immediately transitioned to connected mode 52 with SC base station 12S upon camping on serving cell 18S. Then, when UE device 10 transitions from connected mode 52 to idle mode 54, UE device 10 may perform neighbor cell measurements based on (e.g., according to or using) the measurement objects stored in measurement object database 64. Put differently, UE device 10 may perform the measurement objects stored in measurement database 64 to measure neighbor cells 18N while in idle mode 54, even when UE device 10 otherwise has no a priori knowledge of the frequencies or RATs in use by neighbor cells 18N. This may serve to minimize the risk that UE device 10 enters the idle mode OOS condition as well as re-connection time for UE device 10.

When UE device 10 performs the measurements of a given MO in MO database 64, the measurements may be Layer 1 (L1) measurements that are stored in SIB acquisition and measurement configuration 66. Reselection logic 68 may then determine whether UE device 10 will reselect to a neighbor cell 18N when the UE device re-enters connected mode 52 based on the L1 measurements stored in SIB acquisition and measurement configuration 66 (and performed based on a corresponding MO from MO database 64), feature flags 70, threshold THMO, threshold THSC, threshold THNC, and/or default parameters 78 from memory 62. For example, if reselection logic 68 determines that, given the L1 measurements performed on a given neighbor cell 18N, neighbor cell 18N offers superior wireless performance than the most recent serving cell 18S of UE device 10, UE device 10 may then connected to that neighbor cell 18N when re-entering connected mode 52 from idle mode 54.

Consider a simplest case example in which there is a single neighbor cell 18N adjacent serving cell 18S (FIG. 1). While in connected mode 52 with serving cell 18S, serving cell 18S may transmit downlink data or control information to UE device 10 that identifies the measurement object of neighbor cell 18N. The measurement object of neighbor cell 18N may, for example, identify the frequency and the RAT being used by that neighbor cell to perform wireless communications between its NC base station 12N and UE devices in the neighbor cell. UE device 10 may store the measurement object in MO database 64 for future use when UE device 10 enters idle mode 54.

Once UE device 10 has entered idle mode 54, UE device 10 may perform L1 measurements (e.g., may gather wireless performance metric data such as received signal strength values, received signal strength indicator (RSSI) values, reference signal received power (RSRP) values, signal-to-noise ratio (SNR) values, noise values, etc.) based on the MO stored at MO database 64 and may store the measurements in SIB acquisition and measurement configuration 66. UE device 10 may then process the stored L1 measurements to determine whether to connect to neighbor cell 18N instead of the previous serving cell 18S the next time UE device 10 enters connected mode 52. For example, if the L1 measurements indicate that UE device 10 will exhibit superior wireless performance in communicating using neighbor cell 18N than the most recent serving cell 18S or that the wireless performance of device 10 using neighbor cell 18N will exceed the wireless performance of device 10 using the most recent serving cell 18S by more than a threshold level, UE device 10 may connect to neighbor cell 18N when next entering connected mode 52. This example is illustrative and non-limiting. If UE device 10 receives and is able to decode the mandatory MIB and SIB(s) for neighbor cell 18N, device 10 may instead use the information from the decoded MIB and SIB(s) to perform the L1 measurements.

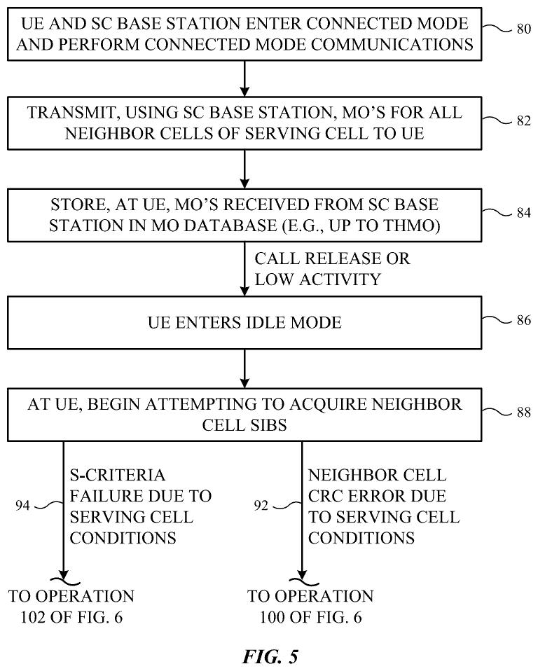

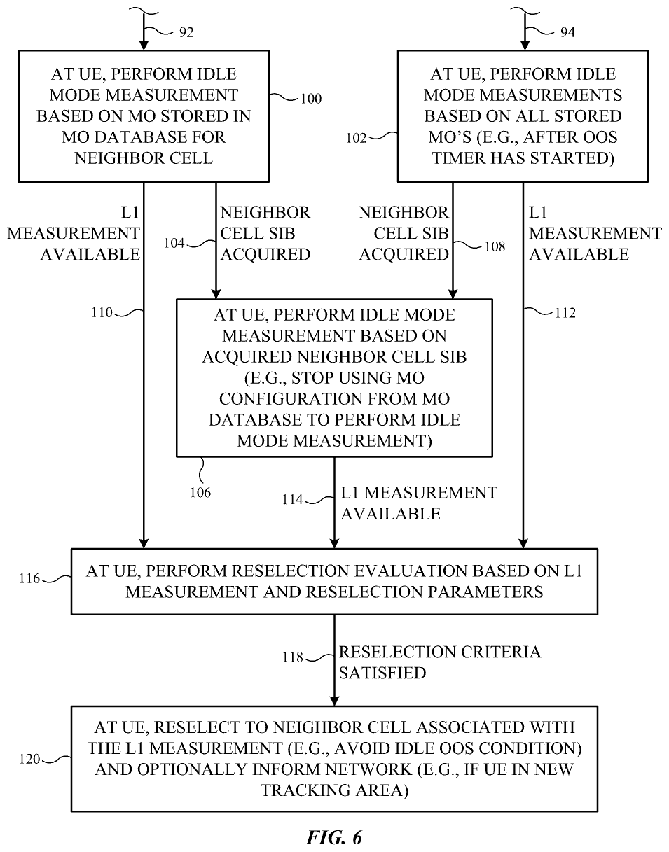

FIGS. 5 and 6 show a flow chart of operations that may be performed by UE device 10 and network 22 to mitigate an idle mode OOS condition for UE device 10. At operation 80 of FIG. 5, UE device 10 may enter connected mode 52 with SC base station 12S (FIG. 1) and may convey wireless data with SC base station 12S while in connected mode 52. For example, SC base station 12S of FIG. 1 may periodically transmit paging signals and/or broadcast signals that contain system information SYSINFA associated with serving cell 18S. UE device 10 may receive the paging signals and/or broadcast signals after powering up wireless circuitry 24 or upon entering the corresponding cell. UE device 10 may camp on serving cell 18S upon successfully decoding the system information SYSINFA in the paging signals and/or broadcast signals (e.g., the MIB and SIB1 for 5G NR or the MIB, SIB1, and SIB2 for LTE) and may then immediately transition to connected mode 52 with SC base station 12S. SC base station 12S and UE device 10 may then exchange wireless data while UE device 10 is in connected mode 52.

At operation 82, while UE device 10 is in connected mode 52 with SC base station 12S, SC base station 12S may transmit measurement objects (sometimes also referred to herein as measurement object configurations) for all neighbor cells 18N abutting, adjacent to, and/or overlapping serving cell 18S. Each measurement object may, for example, identify the frequency resources (frequency information) and the RAT in use by the corresponding neighbor cell 18N. UE device 10 does not have knowledge of the frequency resources or RATs in use by the neighbor cells prior to receiving the measurement objects from SC base station 12S (e.g., because UE device 10 did not have the opportunity to acquire SIBs from neighbor cells 18N before entering connected mode 52 with serving cell 18S).

At operation 84, while UE device 10 is in connected mode 52, UE device 10 may store the measurement objects received from SC base station 12S at MO database 64 (FIG. 4). UE device 10 may, for example, store the measurement objects until reaching the threshold THMO stored on memory 62.

When SC base station 12S performs a connection release on UE device 10 (e.g., due to inactivity, call release, etc.), processing may proceed to operation 86. At operation 86, UE device 10 may enter idle mode 54.

Once in idle mode 54, at operation 88, UE device 10 may periodically listen for paging signals and/or broad cast signals transmitted by SC base station 12S and/or NC base station(s) 12N. UE device 10 may begin attempting to acquire (decode) SIBs (e.g., some or all of system information SYSINFB) transmitted by NC base stations 12N by performing measurements (e.g., L1 measurements) on received signals. If UE device 10 already has knowledge of the SIBs of any neighbor cells 18N, UE device 10 may perform L1 measurements using the frequency and/or RAT associated with or identified by those known SIBs. If channel conditions do not deteriorate in serving cell 18S, processing may proceed to operation 106 of FIG. 6 (e.g., without performing measurements based on the measurement objects transmitted by SC base station 12S while in connected mode 52).

In practice, while in idle mode 54, channel conditions at serving cell 18S may deteriorate. If the channel conditions deteriorate such that a given neighbor cell 18N produces a CRC error (e.g., exceeding threshold THNC stored on memory 62 of FIG. 4) due to poor channel conditions at serving cell 18S, processing may proceed to operation 100 of FIG. 6 via path 92. On the other hand, if the channel conditions deteriorate so much that the serving cell conditions cause UE device 10 to fail the S-parameters of serving cell 18S (e.g., such that UE device 10 is no longer able to successfully decode system information SYSINFA), processing may proceed to operation 102 of FIG. 6 via path 94 and UE device 10 may begin an OOS timer (e.g., a timer with a duration of 10s or other durations set by the corresponding communications protocol).

Turning to FIG. 6, at operation 100, UE device 10 may perform idle mode measurements based on the MO stored at MO database 64 for the corresponding neighbor cell 18N. UE device 10 may, for example, attempt to perform L1 measurements using the RAT and frequency resources identified by the MO for neighbor cell 18N. If UE device 10 performs a sufficient L1 measurement of neighbor cell 18N (e.g., an L1 measurement exceeding a threshold is available to UE device 10), processing may proceed to operation 116 via path 110. If UE device 10 instead acquires a SIB of neighbor cell 18N while processing operation 100, processing may proceed from operation 100 to operation 106 via path 104. While measurement objects are configured by the base station while the UE is in connected mode, a SIB measurement configuration refers to measurements configured by the base station in idle mode using the SIB method.

On the other hand, at operation 102 (e.g., in response to UE device 10 failing the S-parameters of serving cell 18S and after the OOS timer has begun), UE device 10 may perform idle mode measurements based on all of the measurement objects stored at MO database 64 (e.g., for all non-acquired neighbor cell SIBs). UE device 10 may, for example, attempt to perform L1 measurements using the RATs and frequency resources identified by all of the measurement objects stored at MO database 64. Since UE device 10 has knowledge of the measurement objects of the neighbor cells, UE device 10 is much more likely to gather sufficient L1 measurements than when UE device 10 does not receive measurement objects from SC base station 12S. If UE device 10 performs a sufficient L1 measurement of a corresponding neighbor cell 18N (e.g., an L1 measurement exceeding a threshold is available to UE device 10), processing may proceed to operation 116 via path 112. If UE device 10 instead acquires a SIB of neighbor cell 18N while processing operation 102, processing may proceed from operation 102 to operation 106 via path 108.

Operation 106 may be performed when UE device 10 is able to acquire system information SYSINFB (e.g., mandatory neighbor cell SIBs) for a corresponding neighbor cell 18N while processing operations 88-102. At operation 106, UE device 10 may perform idle mode measurements based on the acquired neighbor cell SIB(s) (e.g., using the RAT and/or frequency resources associated with or identified by the acquired neighbor cell SIB(s)) rather than using the measurement objects stored at MO database 64. In this way, UE device 10 may perform measurements most likely to identify a satisfactory cell to reselect to given its current channel conditions regardless of the measurement objects transmitted by SC base station 12S in connected mode (e.g., even if the best-performing cell for UE device 10 has changed since UE device 10 was last in connected mode). If UE device 10 performs a sufficient L1 measurement of the corresponding neighbor cell 18N (e.g., an L1 measurement exceeding a threshold is available to UE device 10), processing may proceed to operation 116 via path 114.

At operation 116, reselection logic 68 on UE device 10 (FIG. 4) may perform a reselection evaluation based on the L1 measurement and reselection parameters (e.g., default parameters 78 of FIG. 4) to determine whether to reselect to the neighbor cell 18N associated with the L1 measurement. For example, reselection logic 68 may determine whether reselection criteria are satisfied. The reselection criteria may be satisfied, for example, if the L1 measurement indicates that UE device 10 will exhibit superior wireless performance in communicating using neighbor cell 18N than serving cell 18S or that the wireless performance of device 10 using neighbor cell 18N will exceed the wireless performance of device 10 using serving cell 18S by more than a threshold level. If the reselection criteria are not satisfied, UE device 10 does not reselect to the neighbor cell for connection the next time UE device 10 enters connected mode 52. If the reselection criteria are satisfied, processing may proceed to operation 120 via path 118.

At operation 120, UE device 10 may reselect to the neighbor cell 18N associated with the L1 measurement that satisfied the reselection criteria. Then, when UE device 10 next transitions to connected mode 52, UE device 10 may connect to neighbor cell 18N (which then becomes the new serving cell 18S) rather than the most recent serving cell 18S. In this way, UE device 10 can perform idle mode measurements of neighbor cells despite not having previous knowledge of the SIBs, frequency resources, or RATs in use by the neighbor cells. This may serve to minimize the risk of entering the OOS timer expiring and UE device 10 entering the idle mode OOS condition while in idle mode 54, thereby minimizing the risk of needing to perform power and time-consuming NAS OOS procedures. If desired, UE device 10 may transmit a signal to inform network 22 that it has reselected to neighbor cell 18N (e.g., in situations where UE device 10 has moved to a new tracking area). The example of FIGS. 5 and 6 are illustrative and non-limiting and, in general, other procedures may be used to avoid idle mode OOS conditions.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The methods and operations described above in connection with FIGS. 1-6 may be performed by the components of UE device 10, base station(s) 12, and/or network 22 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 30 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 32 of FIG. 2, etc.). The processing circuitry may include microprocessors, central processing units (CPUs), application-specific integrated circuits with processing circuitry, or other processing circuitry.

If desired, an apparatus may be provided that includes means to perform one or more elements or any combination of elements of one or more methods or processes described herein.

If desired, one or more non-transitory computer-readable media may be provided that include instructions to cause an electronic device, upon execution of the instructions by one or more processors of the electronic device, to perform one or more elements or any combination of elements of one or more methods or processes described herein.

If desired, an apparatus may be provided that includes logic, modules, or circuitry to perform one or more elements or any combination of elements of one or more methods or processes described herein.

If desired, an apparatus may be provided that includes one or more processors and one or more non-transitory computer-readable storage media comprising instructions that, when executed by the one or more processors, cause the one or more processors to perform one or more elements or any combination of elements of one or more methods or processes described herein.

If desired, a signal (e.g., a signal encoded with data), datagram, information element (IE), packet, frame, segment, PDU, or message may be provided that includes or performs one or more elements or any combination of elements of one or more methods or processes described herein.

If desired, an electromagnetic signal may be provided that carries computer-readable instructions, where execution of the computer-readable instructions by one or more processors causes the one or more processors to perform one or more elements or any combination of elements of one or more methods or processes described herein.

If desired, a computer program may be provided that includes instructions, where execution of the program by a processing element causes the processing element to carry out one or more elements or any combination of elements of one or more methods or processes described herein.

UE device 10 and/or network 22 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A method of operating an electronic device, the method comprising:
conveying, using wireless circuitry in a connected mode, wireless data with a first wireless base station;
receiving, using the wireless circuitry in the connected mode, a measurement object from the first wireless base station, the measurement object being associated with a second wireless base station different from the first wireless base station; and
measuring, using the wireless circuitry in an idle mode, a radio-frequency signal based on the measurement object, the radio-frequency signal being transmitted by the second wireless base station.

2. The method of claim 1, further comprising:
performing, using the wireless circuitry, cell reselection from the first wireless base station to the second wireless base station based on the measurement of the radio-frequency signal.

3. The method of claim 2, wherein the measurement comprises a Layer 1 (L1) measurement.

4. The method of claim 2, further comprising:
conveying, using the wireless circuitry in the connected mode, additional wireless data with the second base station after the cell reselection from the first wireless base station to the second wireless base station.

5. The method of claim 1, wherein the first wireless base station has a first cell and the second wireless base station has a second cell neighboring the first cell.

6. The method of claim 1, wherein the measurement object identifies a frequency of the radio-frequency signal.

7. The method of claim 6, wherein the measurement object identifies a radio access technology (RAT) of the radio-frequency signal.

8. The method of claim 1, wherein the measurement object identifies a radio access technology (RAT) of the radio-frequency signal.

9. The method of claim 8, wherein conveying the wireless data comprises conveying the wireless data using an additional RAT that is different from the RAT.

10. The method of claim 1, further comprising:
receiving, using the wireless circuitry in the connected mode, a set of measurement objects from the first wireless base station, each measurement object in the set of measurement objects being associated with a different respective wireless base station other than the first wireless base station.

11. The method of claim 10, further comprising:
measuring, using the wireless circuitry in the idle mode, radio-frequency signals based on each measurement object in the set of measurement objects.

12. The method of claim 1, further comprising:
receiving, using the wireless circuitry, a broadcast signal from the first wireless base station;
decoding, using the wireless circuitry, a system information block (SIB) of the first wireless base station from the broadcast signal and entering the connected mode with the first wireless base station;
transitioning, using the wireless circuitry, from the connected mode to the idle mode in response to a connection release by the first wireless base station; and
transitioning, using the wireless circuitry, from the idle mode to the connected mode while connecting to the second wireless base station.

13. The method of claim 1, wherein the connected mode comprises a radio resource control (RRC) connected mode and the idle mode comprises an RRC idle mode.

14. An electronic device comprising:
one or more antennas;
one or more radios coupled to the one or more antennas, the one or more radios being configured to use the one or more antennas to
receive, in a connected mode, wireless data transmitted by a wireless base station in a first cell,
receive, in the connected mode, information transmitted by the wireless base station that identifies a frequency of a second cell neighboring the first cell, and
measure, in an idle mode, a radio-frequency signal at the frequency; and
one or more processors configured to perform cell reselection based on the measurement of the radio-frequency signal.

15. The electronic device of claim 14, wherein the information transmitted by the wireless base station further identifies a radio access technology (RAT) of the second cell.

16. The electronic device of claim 15, the one or more radios being configured to measure the radio-frequency signal using the RAT and being configured to receive the wireless data using an additional RAT different from the RAT.

17. The electronic device of claim 14, wherein the connected mode comprises a radio resource control (RRC) connected mode and the idle mode comprises an RRC idle mode.

18. A method of operating a wireless base station in a first cell, the method comprising:
transmitting, using one or more antennas, wireless data to a user equipment (UE) device in the first cell while the UE device is in a radio resource control (RRC) connected mode;
transmitting, using the one or more antennas, a measurement object to the UE device while the UE device is in the RRC connected mode, wherein the measurement object is associated with a second cell different from the first cell; and
transitioning, using the one or more antennas, the UE device from the RRC connected mode to an RRC idle mode, the UE device being configured to perform idle mode measurements on the second cell based on the measurement object transmitted by the wireless base station.

19. The method of claim 18, wherein the measurement object identifies a RAT in use by the second cell, the UE device being configured to perform the idle mode measurements using the RAT identified by the measurement object.

20. The method of claim 18, wherein the measurement object identifies a frequency in use by the second cell, the UE device being configured to perform the idle mode measurements using the frequency identified by the measurement object.
